(19) United States
(12) Patent Application Publication
(10) Pub. No.: US 2016/0026733 A1
(43) Pub. Date: Jan. 28, 2016

(54) Profile-Based Workflow and Information Organization

(71) Applicant: ADP, LLC, Roseland, NJ (US)

(72) Inventors: Scott Crockett, New York, NY (US); Dominic Gadoury, New York, NY (US)

(21) Appl. No.: 14/689,950

(22) Filed: Apr. 17, 2015

Related U.S. Application Data
(60) Provisional application No. 62/029,907, filed on Jul. 28, 2014.

(51) Int. Cl. G06F 17/30; G06F 3/0484

(52) U.S. Cl. CPC G06F 17/30905; G06F 17/30896; G06F 3/04842

(57) ABSTRACT

A method of distributing a content object within a profile-based workflow system. A measure of relevance between the content object and an employer personnel is identified. The measure of relevance is based on interest indicated by the employer personnel in relevant topics of the content object. A reviewer-indicated potential value of the content object is identified. The reviewer-indicated potential value is measured by a determination of a degree to which the content object is distributed to additional employer personnel. The content object is displayed to the employer personnel based on the reviewer-indicated potential value and the measure of relevance.

### CROSS-REFERENCE TO RELATED APPLICATION

This application claims the benefit of priority to U.S. Provisional Patent Application No. 62/029,907, filed Jul. 28, 2014, and entitled “Profile-Based Workflow and Information Organization.”

### BACKGROUND INFORMATION

1. Field

The present disclosure relates generally to an improved data processing system. In particular, the present disclosure relates to a method and apparatus for profile-based workflow and information organization within a workplace information management system. Still more particularly, the present disclosure relates to a method and apparatus for the integrative interactive management of content streams, workflows, worker task and activity organization, and productivity measurement within a workplace information management system.

2. Background

Information systems are used for many different purposes. For example, an information system may be used to provide communication between, and distribute ideas amongst employees within an organization. Businesses rely on collaborative efforts facilitated by this communication to achieve the organizational goals of the business.

However, the information organization methods and systems that are currently used to facilitate communication and collaborative efforts get provide a holistic view of the organizational goals to individual employees. To accomplish a single organizational goal, the business environment often relies on many dependencies among tasks performed by individual employees. These dependencies may not always be readily apparent to the individual employee working on a single aspect of a goal.as a result, individual employees often lack an understanding of how their work effort impacts and enables others to contribute to such goals.

Therefore, it would be desirable to have a method and apparatus that take into account at least some of the issues discussed above, as well as other possible issues. For example, it would be desirable to have a method and apparatus that overcome issues with information organization methods and systems that result in a lack of understanding of the collaborative efforts needed to accomplish business goals of the organization.

### SUMMARY

In one illustrative embodiment, a method of distributing a content object within a profile-based workflow system is provided. A computer system identifies a measure of relevance between the content object and an employer personnel. The measure of relevance is based on interest indicated by the employer personnel in relevant topics of the content object. The computer system identifies a reviewer-indicated potential value of the content object. The reviewer-indicated potential value is measured by a determination of a degree to which the content object is distributed to additional employer personnel. The computer system identifies displaying the content object to the employer personnel based on the reviewer-indicated potential value and the measure of relevance.

In another illustrative embodiment, a graphical display system comprises a computer system and a profile-based workflow system in communication with the display system. The profile-based workflow system identifies a measure of relevance between the content object and an employer personnel. The measure of relevance is based on interest indicated by the employer personnel in relevant topics of the content object. The profile-based workflow system identifies a reviewer-indicated potential value of the content object. The reviewer-indicated potential value is measured by a determination of a degree to which the content object is distributed to additional employer personnel. The profile-based workflow system displays the content object to the employer personnel based on the reviewer-indicated potential value and the measure of relevance.

In yet another illustrative embodiment, a computer program product for distributing a content object within a profile-based workflow system is provided. The computer program product comprises a computer readable storage media. First program code, stored on the computer readable storage media, identifies a measure of relevance between the content object and an employer personnel. The measure of relevance is based on interest indicated by the employer personnel in relevant topics of the content object. Second program code, stored on the computer readable storage media, identifies a reviewer-indicated potential value of the content object. The reviewer-indicated potential value is measured by a determination of a degree to which the content object is distributed to additional employer personnel. Third program code, stored on the computer readable storage media, displays the content object to the employer personnel based on the reviewer-indicated potential value and the measure of relevance.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a block diagram of a profile-based workflow environment depicted in accordance with an illustrative embodiment;

FIG. 2 is an illustration of an illustration of a graphical user interface in a profile-based workflow system depicted in accordance with an illustrative embodiment;

FIG. 3 is an illustration of a contextual relationships within a dashboard of the graphical user interface of a profile-based workflow system depicted in accordance with an illustrative embodiment;

FIG. 4 is an illustration of information feeds within a dashboard of the graphical user interface of a profile-based workflow system depicted in accordance with an illustrative embodiment;

FIG. 5 is an illustration of a graphical user interface for initially distributing a business idea to a set of associated employer personnel, depicted in accordance with an illustrative embodiment;

FIG. 6 is an illustration of a loosely associated business idea within a graphical user interface of a profile-based workflow system depicted in accordance with an illustrative embodiment;

FIG. 7 is an illustration of a comment detail page displayed within graphical user interface of a profile-based workflow system depicted in accordance with an illustrative embodiment;

FIG. 8 is an illustration of a flowchart of a process for increasing visibility of a content object within a profile-based workflow system based on distribution of the content object, depicted according to an illustrative embodiment;

FIG. 9 is an illustration of a flowchart of a process for increasing visibility of a content object within a profile-based workflow system based on feedback to the object, depicted according to an illustrative embodiment;

FIG. 10 is an illustration of a flowchart of a process for displaying a content object within a graphical user interface of profile-based workflow system, based on visibility of the content object according to an illustrative embodiment; and

FIG. 11 is an illustration of a block diagram of a data processing system depicted in accordance with an illustrative embodiment.

### DETAILED DESCRIPTION

The illustrative embodiments recognize and take into account one or more different considerations. For example, the illustrative embodiments recognize and take into account that currently used techniques that provide communication between, and distribute ideas amongst employees within an organization may not be as clear as possible to convey information, such as dependencies among tasks performed by individual employees. The illustrative embodiments recognize and take into account that current techniques that provide communication between, and distribute ideas amongst employees within an organization often result in individual employees that lack an understanding of how their work effort impacts and enables others to contribute to such goals.

The illustrative embodiments recognize and take into account that providing communication between, and distributing ideas amongst employees within an organization may be more difficult to compare than desired. The illustrative embodiments also recognize and take into account that distributing business ideas to employee that may have interest in the idea may be more difficult than desired.

Thus, the illustrative embodiments provide a method and apparatus for graphically displaying data within profile-based workflow system that allows dependencies to be readily organized, viewed, and optionally made available to workers so that they can gain a greater understanding of how their work effort impacts and enables others to contribute to such goals. A user interface can be configured to facilitate visualizing these dependencies in an orbit-like view that structures the dependencies into hierarchical levels of dependence that correspond to relative distance from a central theme while supporting pop-up like viewing of dependency details.

Profile-based workflow and information organization methods and systems described herein may facilitate collaborative efforts, such as refining and embellishing innovative ideas by enabling structured, yet dynamic sharing of ideas, refinements, feedback and the like among members of an organization and/or third parties, such as customers who may provide feedback or may initiate requests for new features in a product, and the like. A user may submit an idea for a new product feature through a profile-based workflow and information organization interface. Submissions may have predefined initial distributions that may be based on aspects of the user's profile. An initial distribution may include the user's direct supervisor, coworkers, a team leader, an invention submission portal, a customer relationship management system, and the like.

A digital object that contains a business idea, concept or objective is potentially relevant to a group of individuals or associates, such as a work group, a business network an enterprise, or the like. The illustrative embodiments provide a set of rules and operative characteristics together with the digital object that govern the progress of the object as it is transmitted through the network. The rules and operative characteristics relate to transmission of the object through the network and actions of particular individuals with respect to the comet.

The illustrative embodiments provide that the object may be transmitted based on anticipated relevance of the comet to individuals within the network, such relevance being determined by various techniques, such as based on keywords or attributes associated with individuals that match keywords or topics associated with the comment, by collaborative filtering techniques that promote transmission to individuals that share interests or attributes with other individuals who have expressed interest, or the like.

Distribution of a digital object according to the illustrative embodiments therefore promote informal brainstorming and facilitates distribution of an idea expressed as part of the digital object on a dynamically measured degree of interest in the idea to members of a network and relevance to the types of things being transmitted over the network by the members. As the idea in the digital object receives positive feedback (e.g. increasing interest), the idea may be distributed to more and more members of the network. The members of the network to receive the comet may be based on relevance of the information in the idea of the comet to work product or other data that the members are accessing or producing. In this way, the illustrative embodiments distribute ideas that are interesting to members in a manner where the idea can gain greater visibility in an organization.

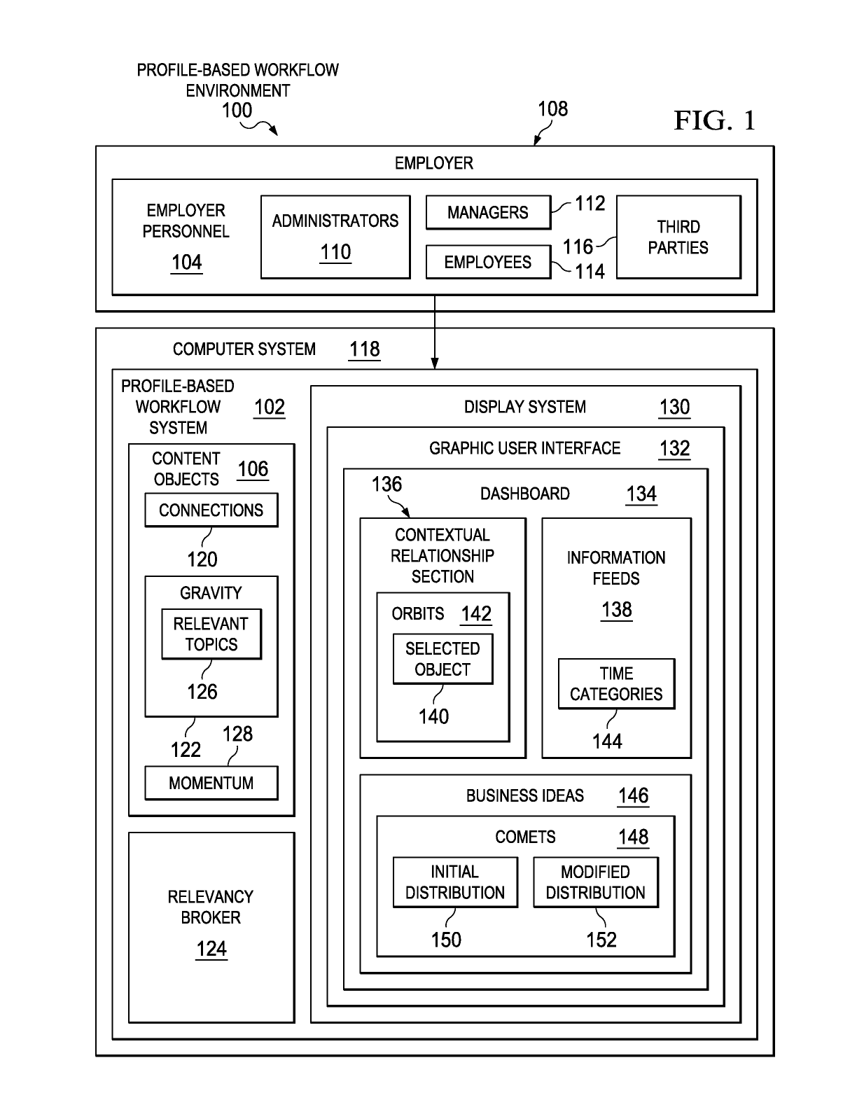

With reference now to the Figures and in particular with reference to FIG. 1, an illustration of a block diagram of a profile-based workflow environment 100 is depicted in accordance with an illustrative embodiment. Profile-based workflow environment 100 includes profile-based workflow system 102.

Profile-based workflow system 102 is used to perform operations with respect to employer personnel 104. The operations can be, for example but not limited to, at least one of providing communication between, and distributing ideas amongst employer personnel 104, so that they can gain a greater understanding of how their individual work effort impacts and enables others of employer personnel 104 to contribute to the activities, goals, deliverables, and the like of employer 108. As depicted, employer personnel 104 are people who are employed by or associated with an entity for which profile-based workflow system 102 is implemented, such as employer 108.

As depicted, employer personnel 104 may include different ones of people who are employed by or associated with employer 108. As depicted, employer personnel 104 can include, but is not limited to, at least one of administrators 110, managers 112, employees 114, and third parties 116.

As used herein, the phrase “at least one of,” when used with a list of items, means different combinations of one or more of the listed items may be used and only one of each item in the list may be needed. In other words, at least one of means any combination of items and number of items may be used from the list but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

As depicted, employer personnel 104 may include administrators 110. Administrators 110 are designated ones of employer personnel 104 that are responsible for managing at least one of the tools, hardware, and software that facilitate generating, controlling, and presenting content within profile-based workflow system 102.

As depicted, employer personnel 104 may include managers 112. Managers 112 are designated ones of employer personnel 104 that are responsible for overseeing content objects 106 entered into profile-based workflow system 102 by employees 114, determining access by employees 114 to content objects 106 within employee-based workflow system 102, and generally ensuring that content objects 106 within employee-based workflow system 102 are appropriate.

As depicted, employer personnel 104 can include employees 114. Employees 114 are ones of employer personnel 104 that perform operations such as organizing, viewing, and making available content objects 106 within profile-based workflow system 102. In an illustrative embodiment, employees 114 may also be administrators 110 or managers 112. In an illustrative embodiment, employees 114 may perform operations to generate content objects 106 through one or more actions, such as but not limited to, at least one of posting ideas, posting comments, uploading files, and creating groups within profile-based workflow system 102.

As depicted, employer personnel 104 can include third parties 116. Third parties 116 are other parties with whom employer 108 has a business relationship, but who may not be under the direct supervision of employer 108. In an illustrative embodiment, third parties 116 can include but are not limited to, at least one of customers of employer 108, vendors of employer 108, regulators of employer 108, and other parties which employer 108 has granted access to profile-based workflow system 102.

Profile-based workflow system 102 can be implemented in computer system 118, where the computer system is a hardware system includes one or more data processing systems. When more than one data processing system is present, those data processing systems may be in communication with each other using a communications medium. The communications medium may be a network. The data processing systems may be selected from at least one of a computer, a workstation, a server computer, a tablet computer, a laptop computer, a mobile phone, a personal digital assistant (PDA), or some other suitable data processing system.

Profile-based workflow system 102 includes content objects 106. Content objects 106 are items that can be organized, viewed, and made available by profile-based workflow system 102 to employer personnel 104. Content objects 106 can be others of employer personnel 104, such as for example but not limited to, at least one of administrators 110, managers 112, employees 114, and third parties 116. Content objects 106 can be a group of employer personnel 104, such as for example but not limited to, at least one of a group of employer personnel 104, a department within employer 108, and an office location of employer 108. Additionally, content objects 106 can be any other of various topics, concepts, ideas, files, and other content managed by profile-based workflow system 102 that can be accessed by and communicated to employer personnel 104. For example, content objects 106 can be a topics, concepts, ideas, files, and other content such as but not limited to, a customer of employer 108, a product of employer 108, event messages, activities, tasks, meetings, business ideas, e-mails, requests, activities, goals, deliverables, areas of job responsibility, and topics of expertise.

Content objects 106 can include connections 120. Connections 120 are relationships that link one of content objects 106 to another related one of content objects 106. Connections 120 can be, for example but not limited to, at least one of connections among employees, customers, vendors, products, goals, activities, deliverables, and other elements of employer 108. By facilitating the visualization of connections 120 between content objects 106, profile-based workflow system 102 provides employer personnel 104 a greater understanding of how their individual work effort impacts and enables others of employer personnel 104 to contribute to the activities, goals, deliverables, and the like of employer 108.

Content objects 106 can include gravity 122. Gravity 122 is a measure of the relevance between one of content objects 106 and other ones of content objects 106 in profile-based workflow system 102, as determined by relevancy broker 124. Gravity 122 is specific to relevant topics 126 of the associated one of content objects 106.

Relevancy broker 124 determines gravity 122 for content objects 106 with respect to each of relevant topics 126 related thereto. Relevancy broker 124 may include semantic engines or other predictive engines which analyze actions and content accessed by employer personnel 104 determines topics of interest relevant to employer personnel 104. As a result, relevancy broker 124 determines gravity 122 of relevant topics 126 within content objects 106, including topics for users, ideas, files, and other content being accessed communicated in profile-based workflow system 102.

Relevant topics 126 are subject matter that relevancy broker 124 determines to be relevant to the associated one of content objects 106. Relevant topics 126 may be established by explicit actions. For example, relevant topics 126 may be established by at least one of employees 114 expressly indicating relevant topics 126, and managers 112 for employees 114 assigning relevant topics 126, such as topics of responsibility or domains of activity, to employees 114.

Conversely, relevancy broker 124 can determine relevant topics 126 for one of content objects 106 based on a demonstration of implicit interest in a topic. Relevancy broker 124 can determine implicit interest as indicated by analysis of the actions of employer personnel 104 within profile-based workflow system 102. For example, network interactions or actions by employer personnel 104 with respect to a particular one of content objects 106 can indicate an implicit interest in relevant topics 126 associated with the object.

Additionally, according to an illustrative embodiment, relevancy broker 124 may include semantic or other predictive engine analyze the content of content objects 106 to determine relevant topics 126 for the object. For example, relevancy broker 124 can mine files and content submissions for a particular one of content objects 106 for keywords, descriptors, phrases, metadata or other indicators that the object is relevant to particular relevant topics 126.

Based on gravity 122 of relevant topics 126 within each of content objects 106, relevancy broker 124 can determine a significance of a particular one of content objects 106 others content objects 106 in profile-based workflow system 102. In one illustrative embodiment, one of content objects 106 representing one of employer personnel 104 may have a relevance to a second one of content objects based on participant-expressed interest in topics associated with the second one of content objects 106. Participant-expressed interest may be derived from contributions by the associated one of employer personnel 104 to the various content objects 106 of profile-based workflow system 102. Contributions by the associated one of employer personnel 104 may include for example but not limited to, at least one of comments on ideas, open discussions, questions, e-mail, data transfer, project affiliations, user profile, accomplishments, training, and role in an organization. Therefore, as employer personnel 104 submit ideas and take other actions relative to a particular one of content objects 106, and those ideas and actions may establish and gravity 122 between the particular one of content object 106 and others of content objects 106.

Relevant topics 126 having a greater gravity 122 may indicate that the topic is important to a wider range of employer personnel 104. For example, if many of employer personnel 104 contribute participant-expressed interest to content objects 106 related to particular ones of relevant topics 126, those relevant topics 126 will gain a high degree of gravity 122 to employer 108 and other content objects 106 related to the particular ones of relevant topics 126. Similarly, many of, or multiple ones of employer personnel 104 submit contributions of participant-expressed interest regarding one of content objects 106, then relevant topics 126 related to the one of content objects 106 will gain a high degree of gravity 122 to the employer 108, and other content objects 106 associated with the relevant topics 126.

Conversely, content objects 106 related to relevant topics 126 having a greater gravity 122 may indicate that a larger level of effort has been expended on the object by one of employer personnel 104. For example, if one of employees 114 submits one of content objects 106 requesting to resolve an issue with human resources, the employee generates gravity 122 for relevant topics 126 within the submitted object by continuing to check the status of the issue. Despite the issue not being resolved over time, relevant topics 126 related to the submitted one of content objects 106 may gain gravity 122. As a result, relevancy broker 124 can expose others of employer personnel 104 the submitted object, and other relevant ones of content objects 106, due to greater gravity 122 of relevant topics 126 related to the submitted one of content objects 106.

Content objects 106 within profile-based workflow system 102 can include momentum 128. Momentum 128 is a reviewer-indicated potential value of a content objects 106, such as idea submitted by one of employees 114 to profile-based workflow system 102, measured by a determination of the degree to which the content object 106 is distributed to additional ones of employer personnel 104. Momentum 128 may therefore include a degree to which the associated one of content objects 106 is distributed to others of employer personnel 104. Content objects 106 can gain momentum 128 when employer personnel 104 cake actions to increase the visibility of the content object 106 to others of employer personnel. These actions can be, for example but not limited to, at least one of employer personnel 104 participating in exchanges about the content object 106, employer personnel 104 forwarding the idea to others of employer personnel 104, and employer personnel 104 indicating associations of the content objects 106 to others of content objects 106 accessible through profile-based workflow system 102. According to an illustrative embodiment, employer 108 may measure the potential value of an ideas based on momentum 128 of related content objects 106.

Momentum 128 may be disproportionately impacted based on particular ones of employer personnel 104 who promotes or ignores content object 106. In an illustrative embodiment, momentum 128 may be disproportionately impacted by particular employer personnel 104 more than others, such as based on a role of the particular employer personnel 104 within employer 108. Employees 114 may have less impact on momentum 128 for content objects 106 than would managers 112, such as for example a chief technology officer of employer 108. Therefore, further distribution of content objects 106 by managers 112 may increase momentum 128 to a much greater degree than if others of employees 114 were to distribute content object 106 to the same set employer personnel 104.

As depicted, profile-based workflow system 102 includes display system 130. In this illustrative example, display system 130 can be a group of display devices. A display device in display system 130 may be selected from one of a liquid crystal display (LCD), a light emitting diode (LED) display, an organic light emitting diode (OLED) display, and other suitable types of display devices.

In this illustrative example, display system 130 includes graphical user interface 132. In this illustrative example, profile-based workflow system 102 can display information such as for example, at least one of content objects 106, or other suitable information in graphical user interface 132.

Employer personnel 104 can interact with profile-based workflow system 102 through graphical user interface 132. Profile-based workflow system 102 may also perform actions in response to receiving user input through graphical user interface 132. These action can include, for example but not limited to, at least one of organizing content objects 106, viewing content objects 106, providing feedback regarding content objects 106, and making content objects 106 available to others of employer personnel 104.

Graphical user interface 132 enables access to workflow and information organization capabilities of profile-based workflow system 102 through manipulation of and interaction with a number of interactive features, such as icons. Each icon displayed within graphical user interface 132 is representative of one of content objects 106. For example, graphical user interface 132 may display icons that represent content objects 106 such as at least one of coworkers, messages, activities, tasks, schedule meetings, e-mails, requests, and the like.

According to an illustrative embodiment, graphical user interface 132 can take the form of dashboard 134. Dashboard 134 is an interface of profile-based workflow system 102 facilitates user productivity by visually depicting contextual relationships section 136 and information feeds 138 within graphical user interface 132.

Dashboard 134 includes contextual relationships section 136. Contextual relationships section 136 is a portion of dashboard 134 that displays connections 120 between content objects 106, organized around a selected object 140. As depicted, selected object 140 is one of content objects 106.

Contextual relationships section 136 may display connections 120 between selected object 140 and others of content object 106 as orbits 142. Orbits 142 is a visual representation of related ones of content objects 106 are organized around selected object 140 within profile-based workflow system 102. Selected object 140 is represented at the center of orbits 142, and provides a context for depicting contextual relationships section 136 and information feeds 138 for other content objects 106 within graphical user interface 132. Connections 120 that link selected object 140 to other related content objects 106 are organized around selected object 140.

According to an illustrative embodiment, selected object 140 may correspond to one of employees 114. Orbits 142 may represent the employee as selected object 140 at the center of orbits 142. Orbits 142 may show connections 120 between selected object 140 and others of content objects 106, including multi-level connections, organized around and extending from selected object 140.

Connections 120 displayed in orbits 142 may be based on a context defined by selected object 140. In an illustrative embodiment, selected object 140 may correspond to one of employees 114. Selected object 140 defines a context in which orbits 142 displays others of content object 106 that are related to the employee. The context can include, for example but not limited to, at least one of a current list of activities of the employee, entries in the employee's calendar, a prioritized e-mail in-box of the employee, and the like.

In an illustrative embodiment, one of employer personnel 104 may have a blend of high priority tasks and low priority tasks to accomplish. High priority tasks may be depicted as connections 120 to others of employer personnel 104. Orbits 142 may visually indicate the status of such tasks on dashboard 134 through a range of effects applied to content objects 106 representing the tasks. Such effects can include but are not limited to, a color of the content objects 106, a size of the content objects 106, an animation of the content objects 106, and the like.

Therefore according to an illustrative embodiment, orbits 142 of dashboard 134 may facilitate centering views on selected object 140, such that connections 120 to others of content objects 106 are displayed within dashboard 134 in the context of selected object 140. In an illustrative embodiment, selected object 140 is one of content object 106, such as a meeting, a co-worker, a group, a department, a remote office, a file, a customer, a product, an event, and the like.

In an illustrative embodiment, employer personnel 104 may select one of content objects 106 corresponding to a meeting that the employer personnel 104 is scheduled to attend. Employer personnel 104 may designate the content objects 106 corresponding to the meeting as selected object 140 by dragging the object into a central position within orbits 142. By virtue of being designated as selected object 140, the meeting becomes the center of orbits 142 and others of content objects 106 having connections 120 to selected object 140, are organized around the meeting. Other contents objects 106 having connections 120 selected object 140 can include content objects 106 corresponding to at least one of information about the meeting and others of employer personnel 104 scheduled to attend the meeting.

Continuing with the above embodiment, when viewing orbits 142 within the context of the meeting, orbits 142 may display content objects 106 having connections 120 to selected object 140. For example, orbits 142 may display an attendee to the meeting having connections 120 to the meeting depicted as selected object 140. In the illustrative embodiment, the attendee is presenting a status report during the meeting. When this attendee has completed the status report to be presented, the status report may appear in orbits 142 of dashboard 134 as a new one of content objects 106 having connections 120 to the content object 106 of the attendee. The user may view the status report by selecting its corresponding content objects 106 from orbits 142.

Dashboard 134 includes information feeds 138. Information feeds 138 is a portion of dashboard 134 that chronologically displays and organizes information feeds, such as at least one of activities, tasks, and the like.

Relevancy broker 124 receives and processes information feeds, which may generally comprise content streams, to facilitate organization into information feeds 138 based on profile, workflow, priorities, time, and the like. In an illustrative embodiment, information feeds are content objects 106, or actions taken with respect to content objects 106, within profile-based workflow system 102.

Content objects 106, or actions taken with respect to content objects 106, that comprise the information feeds 138 can be received by direct input from employer personnel 104. Conversely, content objects 106, or actions taken with respect to content objects 106, that comprise the information feeds 138 can be received from contextually relevant sources. The contextually relevant sources can include at least one of human resource systems, event systems, feedback systems, time card systems, payment systems, e-mail systems, file and file sharing systems, and the like.

In an illustrative embodiment, relevancy broker 124 organizes content objects 106 into information feeds 138 based on priorities that may be associated with the content object 106. The priorities may be set by a user's manager, a project plan, an incoming message priority status, an e-mail sender (e.g. the chief executive officer), and the like.

Relevancy broker 124 may therefore facilitate a first level of triage or prioritization for handling content received. Relevancy broker 124 may mine content objects 106 received through content streams for keywords that facilitate organization into time categories 144. Time categories 144 are prioritized task lists for content objects 106 received through content streams based at least partially on an associated chronology for content objects 106.

In an illustrative embodiment, time categories 144 may show a recap of key accomplishments and/or incomplete tasks from the previous workday, highlights of items slated for the present workday, and a preview of key activities scheduled for a future date. Time categories 144 may have other time-based designators, such as for example but not limited to, at least one of soon, recently, and the like. As work is completed, associated content objects 106 may appear in a “recently” feed. As work becomes due soon, associated content objects 106 may appear in an “soon” feed.

In an illustrative embodiment, one of content objects 106 received in a content streams may be associated with a delivery/receipt date and due date. The due date can be, for example a date for replying to a customer e-mail. Relevancy broker 124 organizes content objects 106 into time categories 144 based on keywords mined from the content objects 106. For example, if one of content objects 106 shows a due date of Monday and today is Tuesday, relevancy broker 124 would not place that object that object into one of time categories 144 that corresponds to a user's current task list. However, a message in one of content objects 106 asks how soon a user can provide a file may be interpreted as needing a response today. Relevancy broker 124 would place the object into one of time categories 144 that corresponds to a user's current task list.

In an illustrative embodiment, information feeds 138 of dashboard 134 may show a recap of key accomplishments and/or incomplete tasks from yesterday, highlights of items slated for today, and a preview of key activities for tomorrow. Information feeds 138 may have other time-based designators such as soon, recently, and the like. As work is completed, their corresponding content objects 106 may appear in a “recently” feed of time categories 144. As work becomes due soon, corresponding content objects 106 may appear in a “soon” feed of time categories 144.

Illustrative embodiment, contextual relationships section 136 and information feeds 138 may impact each other. In an example, a user may identify an upcoming meeting in information feeds 138 by selecting one of content objects 106 that corresponds to the meeting. By dragging the content object 106 from information feeds 138 to orbits 142 of contextual relationships section 136, the user designates the meeting as selected object 140. An orbit-based representation of the content objects 106 for the meeting may be displayed in orbits 142. Such a representation may show connections 120 of the meeting, represented has object 140, to other of content objects 106 related to the meeting. Such other content objects 106 can include for example, at least one of content objects 106 for attendees, documents, projects, departments, agenda, and the like that have connections 120 to the meeting.

In an illustrative embodiment, contextual relationships section 136 and information feeds 138 of dashboard 134 may be organized so that content objects 106 of higher priority items are more likely to be readily visible to the user. For example, relevancy broker 124 may depict content objects 106 of higher priority items at or near the top of time categories 144 that may be displayed in information feeds 138. Additionally, relevancy broker 124 may depict content objects 106 of higher priority items in a default foreground location of orbits 142 that may be displayed in contextual relationships section 136.

Dashboard 134 can include business ideas 146. Business ideas 146 are content objects 106 that contain a business idea, concept or objective potentially relevant to one or more of employer personnel 104. For example, business ideas 146 may be potentially relevant to individuals or groups of at least one of administrators 110, managers 112, employees 114, and third parties 116. The individuals or groups can be associated ones of employer personnel 104, such as a work group, a business network an enterprise, or the like. According to an illustrative embodiment, business ideas 146 can be comet 148.

Employer 108 may rely on collaborative efforts of employer personnel 104 to achieve business goals of employer 108. These collaborative efforts can include, for example, refining and embellishing innovative ideas by enabling structured, yet dynamic sharing of ideas, refinements, feedback and the like among employer personnel 104. Comet 148 facilitates such collaborative efforts among employer personnel 104 who may provide feedback on business ideas 146 of comet 148, may initiate requests for new product features in a business ideas 146 of comet 148, and the like.

Comet 148 is business ideas 146, together with a set of rules and operative characteristics that govern the progress of comet 148 as it is distributed to employer personnel 104 through profile-based workflow system 102. The rules and operative characteristics relate to transmission and distribution of comet 148 to employer personnel 104 through profile-based workflow system 102 and actions of comet 148 with respect to particular employer personnel 104.

In an example of facilitated collaboration enabled by profile-based workflow system 102, employee 114 may submit business idea 146 for a new product feature through graphical user interface 132. Business idea 146 is submitted into profile-based workflow system 142 as comet 148.

Comet 148 may store and convey information, for example at least one of information about business idea 146, information about the level of interest in business idea 146, prioritization of business idea 146, and information reflecting contributions of employer personnel 104 that have previously interacted with comet 148. Such information may take the form of text and/or various multi-media formats, including but not limited to, at least one of audio, video, animations, and presentation materials in various formats, including formats compatible with business applications. Comet 148 may solicit further contributions, including soliciting indications of level of interest in comet 148, level of priority of comet 148, and commentary or contributions regarding content of comet 148.

Comet 148 includes initial distribution 150. Initial distribution 150 is ones of employer personnel 104 selected by relevancy broker 124 as initial recipients of comet 148. In an illustrative embodiment, initial distribution 150 may be based on aspects of the user's profile. For example, initial distribution 150 may include employer personnel 104 having connections 120 to employee 114 that submits comet 148. Initial distribution 150 may include employer personnel 104, such as at least one of the user's direct supervisor, coworkers, a team leader, an invention submission portal, a customer relationship management system, and the like. In an illustrative embodiment, initial distribution 150 may include employer personnel 104 having connections 120 to employee 114 when employee 114 is selected object 140 in orbit 142.

In an illustrative embodiment, initial distribution 150 of comet 148 may be adapted based on at least one of aspects of business idea 146, aspects of employee 114, and feedback from employer personnel 104 included in initial distribution 150. In an illustrative embodiment of adapting initial distribution 150 for comet 148, manager 112 is responsible for reviewing submissions from employee 114, and is included in initial distribution 150. However, manager 112 may be away from the office. Manager 112 has indicated that an alternate one of employer personnel 104 is to be contacted for items being received while manager 112 is away. Initial distribution 150 may therefore be adapted to include the alternate one of employer personnel 104.

In an illustrative embodiment, designation of an alternate reviewer may also be automatically determined based on a range of aspects of business idea 146 submitted from employee 114. Such aspects can include, for example but not limited to, at least one of, priority of business idea 146, priority of one or more projects associated with business idea 146, content of business idea 146, the role or position within an organizational hierarchy of employer 108 of employer personnel 104 for submitting business idea 146, and the like.

An illustrative embodiment, initial distribution 150 of comet 148 can be adapted based on feedback from employer personnel 104 within initial distribution 150. For example, manager 112 is responsible for reviewing submissions from employee 114, and is included in initial distribution 150. Manager 112 can indicate that an initial priority of comet 148 is too low or too high. Manager 112 can adapt initial distribution 150 accordingly. In an illustrative embodiment, manager 112, or others of employer personnel 104 within initial distribution 150, can adapt initial distribution 150 by expanding initial distribution 150 to include others of employer personnel 104 having connections 120 to manager 112 when manager 112 is selected object 140 in orbit 142. Adapting initial distribution 150 to include others of employer personnel 104 increases momentum 128 of comet 148.

Initial distribution 150 of comet 148 may be adapted to modified distribution 152 based on an increase to at least one of gravity 122 of comet 148 and momentum 128 of comet 148. Modified distribution 152 is ones of employer personnel 104 selected by relevancy broker 124 as recipients of comet 148 based at least in part on gravity 122 of comet 148 and momentum 128 of comet 148.

As stated above, comet 148 is one of content objects 106 existing within profile-based workflow system 102. Information exchanged over or monitored by profile-based workflow system 102, such as participant-expressed interest in comet 148, can be used to impact behavior of comet 148, such as participant-expressed interest in comet 148. As employer personnel 104 submit ideas and take other actions relative to comet 148, those ideas and actions establish and increase gravity 122 of comet 148 with respect to relevant topics 126 of comet 148.

In an illustrative embodiment, comet 148 may be transmitted to employer personnel 104 based on an anticipated relevance of comet 148 to employer personnel 104. Relevancy broker 124 may automatically associate comet 148 with ones of employer personnel 104 based on a high degree of gravity 122 to relevant topics 126 that are common to both comet 148 and employer personnel 104.

In an illustrative embodiment, relevance of comet 148 to employer personnel 104 can be determined based on a comparison between gravity 122 of comet 148 to relevant topics 126, and gravity 122 of employer personnel 104 to relevant topics 126. The comparison between gravity 122 of comet 148 and employer personnel 104 can be based on gravity 122 for relevant topics 126 generated from keywords or attributes associated with employer personnel 104 that match gravity 122 for relevant topics 126 generated from keywords or topics associated with comet 148. In a further illustrative embodiment, the comparison can be based on collaborative filtering techniques that promote transmission to individuals that share interests or attributes with other individuals who have expressed interest, or the like.

In an illustrative embodiment, as comet 148 increases in momentum 128, relevancy broker 124 can direct comet 148 to others of employer personnel 104 that have lesser gravity 122 for relevant topics 126 that are associated with comet 148. That is, the more that relevant topics 126 in comet 148 are determined to be relevant to employer personnel 104 based on information exchanged within profile-based workflow system 102 regarding relevant topic 126, relevancy broker 124 assumes comet 148 to be relevant to additional employer personnel 104.

Comet 148 may be delivered to employer personnel 104 electronically, such as to an e-mail inbox, a dashboard or similar productivity interface, by social network interface, or any other electronic communications interface. In an illustrative embodiment, based on the gravity 122 and momentum 128 of comet 148, relevancy broker 124 can push highly relevant comets, along with their statistics, to information feeds of information feeds 138 within dashboard 134. Additionally, relevancy broker 124 may display comet 148 within contextual relationships section 136 of dashboard 134. When displayed in contextual relationships section 136, comet 148 is displayed as having a loose association with selected object 140. Comet 148 is displayed as having a loose association with selected object 140 when selected object 140 does not have connections 120 with comet 148.

The nature of the delivery of comet 148 may serve as an indicator of the potential relevance of comet 148, overall, or to individual ones of employer personnel 104. In an illustrative embodiment, comet 148 that is determined to be highly relevant based on at least one of a high degree of gravity 122 and a high degree of momentum 128 can be graphically indicated within graphical user interface 132.

In an illustrative embodiment, relevancy broker 124 may dynamically adjust the display comet 148 within graphical user interface 132 depending on a variety of different factors. Comet 148 having a high degree of at least one of gravity 122 and momentum 128 may be displayed more prominently.

For example, relevancy broker 124 can present comet 148 that is determined to be highly relevant within graphical user interface 132, for example, as at least one of urgent items presented in information feeds 138, urgent items presented in larger font within information feeds 138, or urgent items presented in contextual relationships section 136 with attention-gathering graphical elements. The graphical elements can be, for example, at least one of a relative size of comet 148, a relative brightness of comet 148, and an animation applied to comet 148. In this manner, relevancy broker 124 can indicate highly relevant ideas or concepts within graphical user interface 132 by displaying “large” or “bright” comets 148.

In an illustrative embodiment, relevancy broker 124 may dynamically adjust the display of comet 148 within graphical user interface 132 depending on a variety of different factors. Comet 148 having at least one of higher gravity and higher momentum may be displayed more prominently.

In an illustrative embodiment, comet 148 may have multiple types of gravity 122. For instance, an article more appropriate for a personal setting may have a lower gravity if accessed from a computer at the individual's workplace. Likewise, comets with momentum derived from co-workers may be displayed more prominently if accessed at work than a comet with higher momentum from an individual's non-work friends.

In this manner, comet 148 promotes informal brainstorming and facilitates access to and distribution of business idea 146 expressed as part of comet 148 based on a dynamically measured degree of interest in business idea 146 to members of a network and relevance to the types of things being transmitted over the network by the members, such as at least one of e-mail, business documents, and the like. As business idea 146, comet 148 receives positive feedback, increasing gravity 122 of comet 148, comet 148 may be distributed to more and more of employer personnel 104.

The selection of employer personnel 104 by relevancy broker 124 to receive comet 148 may be based on relevance of the information in business idea 146 of comet 148 to work product or other data that the employer personnel 104 are accessing or producing within profile-based workflow system 102. In this way, business ideas 146 that are interesting to particular employer personnel 104 can gain greater visibility in an organization as an idea worth pursuing.

Additionally, when business idea 146 in comet 148 is relevant to work product of a particular one of employer personnel 104, the information in comet 148 may be offered to that personnel for comments to gauge the interest in business idea 146. Comets 148 with a high degree of participant-expressed interest, as determined by gravity 122 of comet 148, may indicate that associated relevant topics 126 are urgent or important to employer 108. Relevancy broker 124 may therefore direct comets 148 of urgent or important relevant topics 126 to decision makers of employer 108, such as managers 112.

In an illustrative embodiment, when comet 148 is both highly relevant, as determined by gravity 122 of comet 148, and has high participant-expressed interest, as determined by momentum 128 of comet 148, relevancy broker 124 may trigger additional actions in profile-based workflow system 102. These additional actions may include, for example but not limited to, adding business idea 146 in comet 148 to meeting agendas and the like. Profile-based workflow system 102 may add business idea 146 to meeting agenda by creating connections 120 between business idea 146 and content object 106 that represents the meeting.

In an illustrative embodiment, comet 148 can also be used to represent employer personnel 104 or content object 106 and the relevant topics 126 associated with those people or objects. For instance, managers 112 may be associated with comet 148 that is used for training or evaluation purposes of employees 114. Comet 148 may also be used to determine employer personnel 104 that would work together for purposes such as determining which teams to assemble for a project.

Business ideas 146 involving certain products may have initial distribution 150 that includes manager 112 responsible for managing content object 106. The momentum and gravity of comet 148 for content object 106 may be ascertained to determine the popularity of the item or the interaction of the object with people, ideas, as well as other objects.

As a result, computer system 118 operates as a special purpose computer system in which relevancy broker 124 in computer system 118 enables informal brainstorming between members and facilitates access to and distribution of relevant content as part of a profile-based workflow system based on a dynamically measured degree of interest in the content. Relevancy broker 124 facilitates collaboration through use of analytics collected as an idea move through an initial or adapted distribution.

While many ideas are developed under formal projects or initiatives, others may not be closely tied to specific projects. The analytics collected may be used as a measure of an idea's potential value to an organization. If an idea receives positive feedback, and is forwarded by reviewers to others outside the initial distribution, the degree to which this idea gets more widely distributed may be used as an indication of its potential value. The more reviewers passing the idea onto others to review, the greater potential value or momentum the idea may be gained. An organization may rely on these measures of momentum to that ideas thereby allowing the members of the organization to have a direct impact on which ideas were promoted interim more organize projects, and the like. Likewise, ideas that lose momentum may also not be pursued by the organization. Such collaboration may enable informal brainstorming ideas without being tied to formal project. Momentum gained/lost by the idea may convince the organization that the idea has greater potential value and therefore may be a real initiative to pursue.

Therefore, relevancy broker 124 enables informal brainstorming between members and facilitates access to and distribution of relevant content as part of a profile-based workflow system based on a dynamically measured degree of interest in the content to be performed as part of profile-based workflow system 102. Thus, relevancy broker 124 transforms computer system 118 into a special purpose computer system as compared to currently available general computer systems that do not have relevancy broker 124.

The illustration of profile-based workflow system 102 in FIG. 1 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

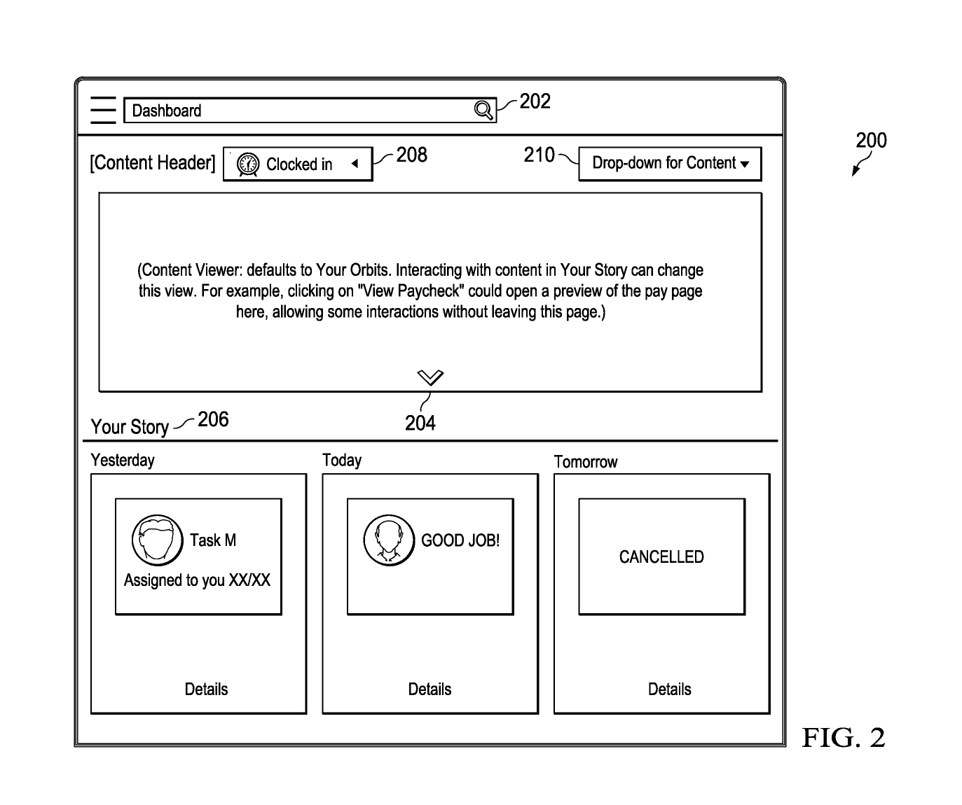

With reference next to FIG. 2, an illustration of a graphical user interface in an profile-based workflow system is depicted in accordance with an illustrative embodiment. As depicted, graphical user interface 200 is an example of graphical user interface 132 in FIG. 1.

As depicted, graphical user interface 200 includes dashboard 202. Dashboard 202 in example of dashboard 134 of FIG. 1. As depicted, dashboard 202 includes contextual relationships section 204 and information feeds 206.

As depicted, dashboard 202 may also include employee status 208 and universal filters 210. Employee status 208 is an input by which employee, such as one of employer personnel 104 of FIG. 1, can input a current status into profile-based workflow system 102 of FIG. 1 utilizing dashboard 202. Employee status 208 can accept inputs from employee by typing text directly into employee status 208. Additionally, employee status 208 can include a menu, such as a drop-down menu, from which an employee can input common status selections into profile-based workflow system 102 utilizing dashboard 202. Employee status 208 can provide additional context for depicting contextual relationships section 136 of FIG. 1 and information feeds 138 of FIG. 1 for other content objects 106 of FIG. 1 within graphical user interface 200.

Universal filters 210 is a graphical user input that allows employee to selectively viewed particular content object 106 within a context provided by a selection from universal filter 210. Universal filters 210 can accept inputs from an employee by receiving tight text directly into universal filter 210. Additionally, universal filter 210 can include a menu, such as a drop-down menu, from which an employee can input common filter selections into profile-based workflow system 102 utilizing dashboard 202. Universal filters 210 can include common filter such as but not limited to, at least one of projects, teams, online users, clocking users, groups, conversations, file transfers, feedback, and meetings, as well as other filters which an employee may frequently utilize. Universal filter 210 can provide additional context for depicting contextual relationships section 136 and information feeds 138 for other content objects 106 within graphical user interface 200. More specifically, universal filter 210 provide context for depicting contextual relationships section 136 within contextual relationships section 204, and for depicting information feeds 138 within information feeds 206.

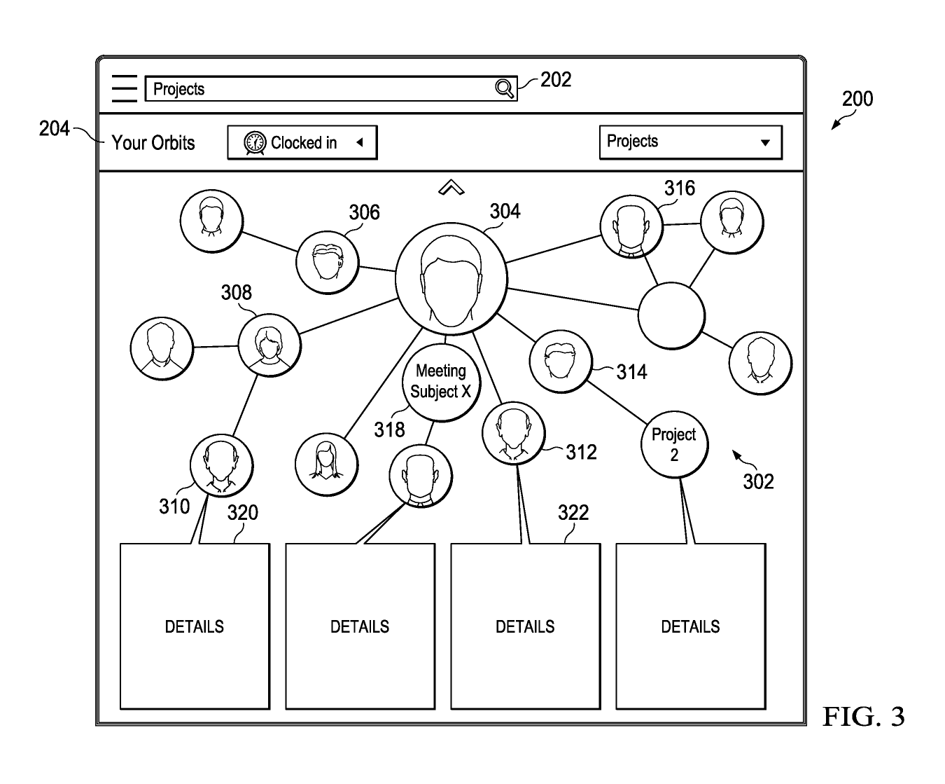

With reference next to FIG. 3, an illustration of a contextual relationships section 204 within the dashboard 202 of graphical user interface 200 of a profile-based workflow system is depicted in accordance with an illustrative embodiment. As depicted, contextual relationships section 204 depicts orbit 302.

As depicted, orbit 302 is an example of is an example of orbit 142 in FIG. 1. Employee 304 is depicted at the center of orbit 302. Employee 304 is one of employer personnel 104 of FIG. 1. Because employee 304 is depicted at the center of orbit 302, employee 304 is selected object 140. Employee 304 therefore provides a context for depicting connections 120 between employee 304 and other content objects displayed in orbit 302. As depicted, orbit 302 shows connections 120 between employee 304 and other content objects 306, 308, 310, 312, 314, 316, and 318.

As depicted, content objects 306, 308, 310, 312, 314, and 316 are others employees, such as employer personnel 104. Connections 120 of FIG. 1 between employee 304 and content objects 306, 308, 310, 312, 314, and 316 can be formed based on, for example but not limited to, pre-existing relationships indicated by employee 304 and interactions between employee 304 with the other employer personnel, such as e-mail interaction.

As depicted, content objects 318 is a meeting which employee 304 is scheduled to attend. Profile-based workflow system 102 of FIG. 1 can create connections 120 between employee 304 and content object 318 when employee 304 is invited to, scheduled for, or RSVPs to the meeting associated with content object 318.

As depicted, profile-based workflow system 102 can display details 320 for content object 314 and details 322 for content object 316 within contextual relationships section 204. Each of details 320 and details 322 are additional information for their related content objects. An employee, such as employee 304, can view details 320 and details 322 by selecting, clicking, mousing over, or otherwise indicating content objects 314 and content object 316 within contextual relationships section 204.

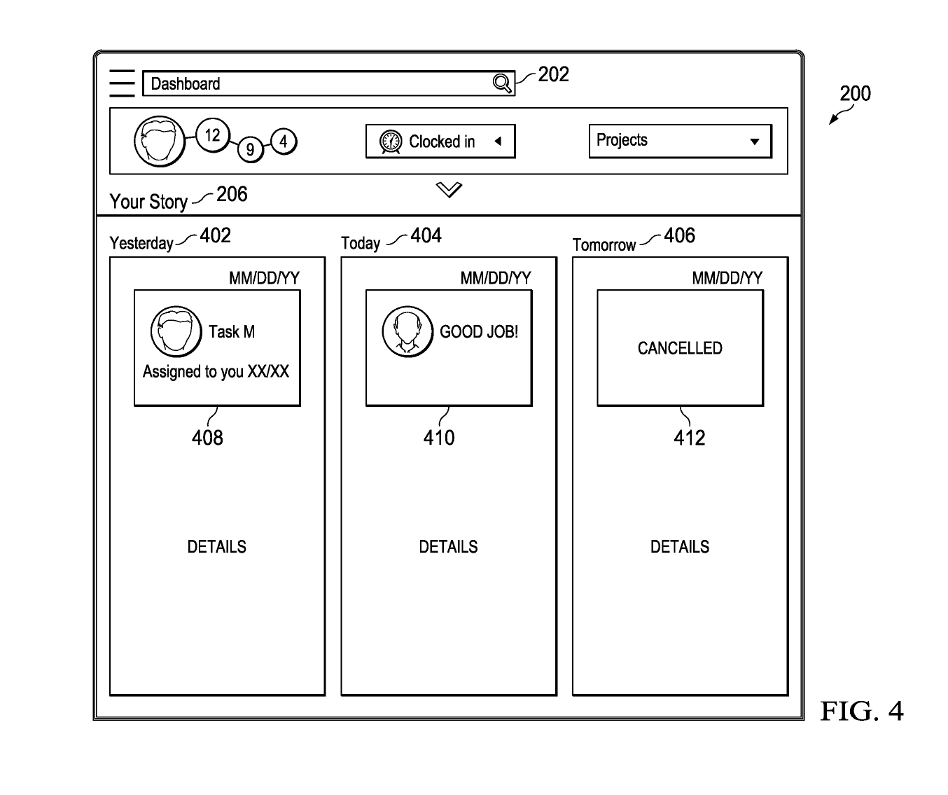

With reference next to FIG. 4, an illustration of an information feeds 206 within the dashboard 202 of graphical user interface 200 of a profile-based workflow system is depicted in accordance with an illustrative embodiment. As depicted, information feeds 206 depicts time categories 402, 404 and 406.

Each of time categories 402, 404, and 406 are examples of time categories 144 of FIG. 1. As depicted, time categories 402 is labeled, “Yesterday.” Time categories 402 displays content objects 408. Each of content objects 408 are examples of content objects 106 of FIG. 1. Specifically, time categories 402 is one of information feeds 206 that shows a recap of completed user actions related to content objects 408. These are actions can include, for example but not limited to, at least one of key accomplishments and incomplete tasks from the previous workday. As employee 304 of FIG. 3 completes action items associated with content objects 410 or content objects 412, relevancy broker 124 may transfer the objects from time categories 404 into time categories 406 or time categories 402.

As depicted, time categories 404 is labeled, “Today.” Time categories 404 displays content objects 410. Time category 404 is one of information feeds 206 that highlights content objects 410 and associated user actions that are slated for the present workday. As employee 304 completes action items associated with content objects 410, relevancy broker 124 may transfer content objects 410 from time categories 404 to time category 402.

As depicted, time categories 406 is labeled “Tomorrow.” Time categories 406 displays content objects 412. Time categories 406 is one of information feeds 206 that provides a preview of key activities related to content objects 412 that are scheduled for a future date. Relevancy broker 124 of FIG. 1 may display content objects 412 in time category 406 As work or other actions associated with content objects 412 becomes due soon. As employee 304 completes action items associated with content objects 412, relevancy broker 124 may transfer content objects 412 from time categories 406 to time category 402.

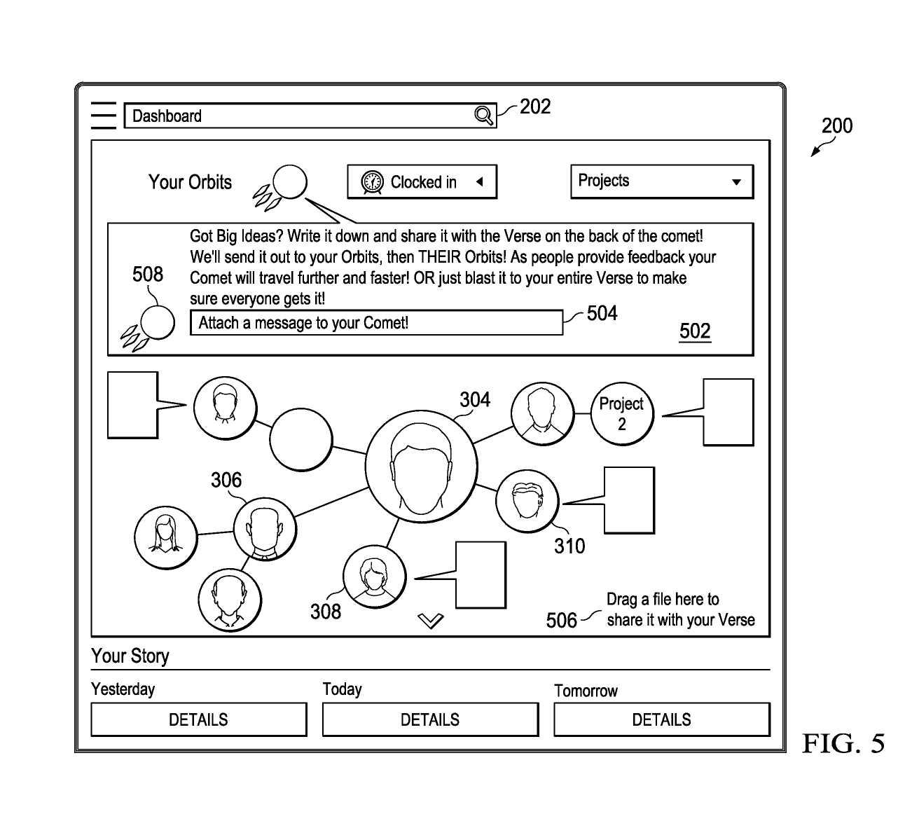

With reference next to FIG. 5, an illustration of a graphical user interface for initially distributing a business idea to a set of associated employer personnel is depicted in accordance with an illustrative embodiment. As depicted, dashboard 202 of graphical user interface 200 displays control window 502 for designating an initial distribution of business idea 504.

Business idea 504 is an example of business idea 146 of FIG. 1. Profile-based workflow system 102 of FIG. 1 stores business idea 504 as one of content objects 106. Employee 304 can initially distribute business idea 504 to initial distribution 150 of FIG. 1 by dragging or otherwise associating business idea 504 with designated area 506 of contextual relationships section 204 of dashboard 202. Because business idea 504 does not have connections 120 to other content objects 106 of FIG. 1, profile-based workflow system 102 indicates business idea 504 as comet 508. Comet 508 is an example of comet 148 of FIG. 1.

As depicted, employee 304 has connections 120 of FIG. 1 to content objects 306, 308, 310, and 312. Content objects 306, 308, 310, and 312 are others of employer personnel 104 of FIG. 1. In an illustrative embodiment, relevancy broker 124 of FIG. 1 selects content objects 306, 308, 310, and 312 to form initial distribution 150 of comet 508.

In an illustrative embodiment, initial distribution 150 may be based on profile aspects of employee 304. For example, initial distribution 150 may include employer personnel 104 having connections 120 to employee 304 that submits comet 508. For initial distribution 150 for comet 508, relevancy broker 124 displays comet 508 within dashboard 202 of connected employees 306, 308, 310, and 312.

If employee 304 is manager 112, employee 304 can use control window 502 to blast comet 508 to all employer personnel 104 of employer 108 of FIG. 1. Thus, a manager 112 may adapt initial distribution 150 of comet 508 based on at least one of aspects of business idea 146, aspects of employee 114, and feedback from employer personnel 104 included in initial distribution 150.

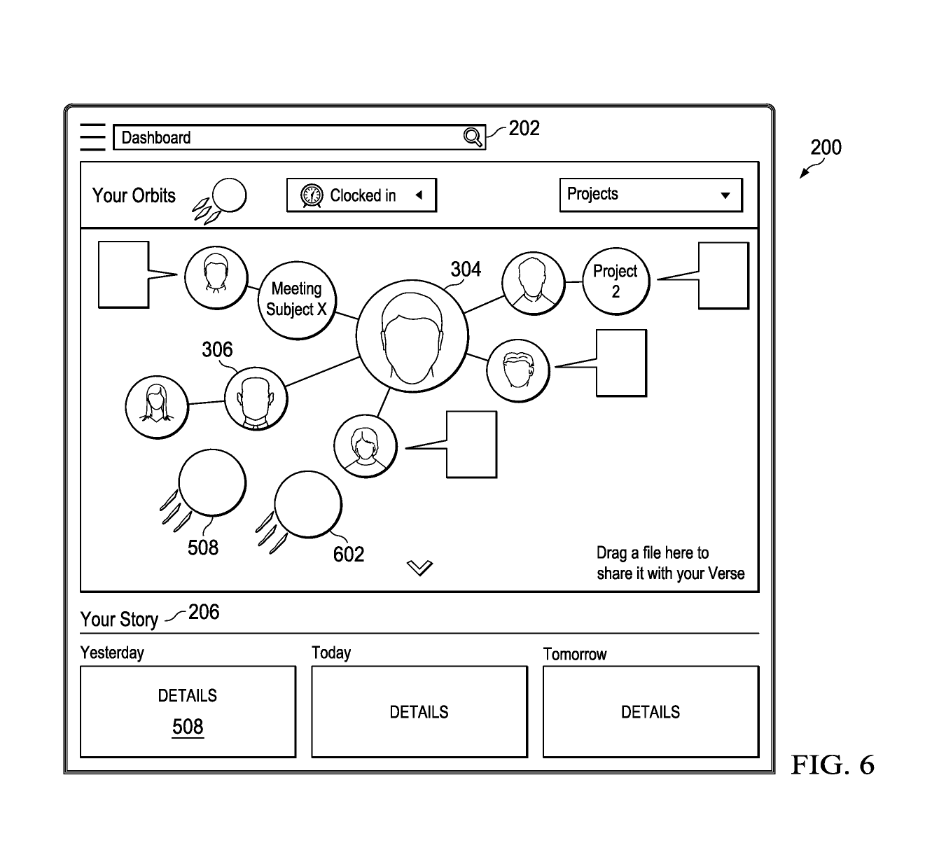

With reference next to FIG. 6, an illustration of a graphical user interface for displaying a business idea is in a graphical user interface of a set of associated employer personnel is depicted in accordance with an illustrative embodiment. As depicted, dashboard 202 of graphical user interface 200 displays comet 508 and comet 602.

Relevancy broker 124 of FIG. 1 displays comet 508 and comet 602 within contextual relationships section 204 of FIG. 2 of dashboard 202. Relevancy broker 124 displays comet 508 and comet 602 as having a loose association with selected object 140 of FIG. 1. Employee 304, depicted as selected object 140, has a loose association with comet 508 and comet 602 because employee 304 does not have connections 120 of FIG. 1 to comet 508 and comet 602.

Relevancy broker 124 displays comet 508 within information feeds 206 of dashboard 202. As depicted, comet 508 is displayed within time categories 402 of FIG. 4, labeled, “Yesterday,” based on content parsed by relevancy broker 124 from business idea 504 of FIG. 5 of comet 508. For example, Relevancy broker 124 displays comet 508 within information feeds 206 based on an association of business idea 504 with completed user actions related to content objects 408. Alternatively, Relevancy broker 124 displays comet 508 within information feeds 206 based on business idea 504 may not including any impending deadlines for which employee 304 must perform action.

Upon receipt of comet 508, connected employees 306, 308, 310, 312, 314, and 316 can contribute to the momentum of comet 508 by forwarding comet 602 to others of employer personnel 104. The momentum can be, for example momentum 128 of FIG. 1. By forwarding comet 508 to additional employer personnel 104, connected employees 306, 308, 310, 312, 314, or 316 indicate a potential value of business idea 504 of comet 508. By distributing comet 508 to additional employer personnel 104, connected employees 306, 308, 310, 312, 314, or 316 increase the visibility of the comet 508.

Based in part by momentum of comet 508, relevancy broker 124 can automatically distribute comet 508 to other content objects 106, such as object representing employer personnel 104, which share a large amount of gravity 122 for relevant topics 126 with comet 508. As comet 508 gains greater momentum, relevancy broker 124 can automatically distribute comet 508 to other content objects 106, such as object representing employer personnel 104, which have a lesser amount of gravity 122 for relevant topics 126 with comet 508.

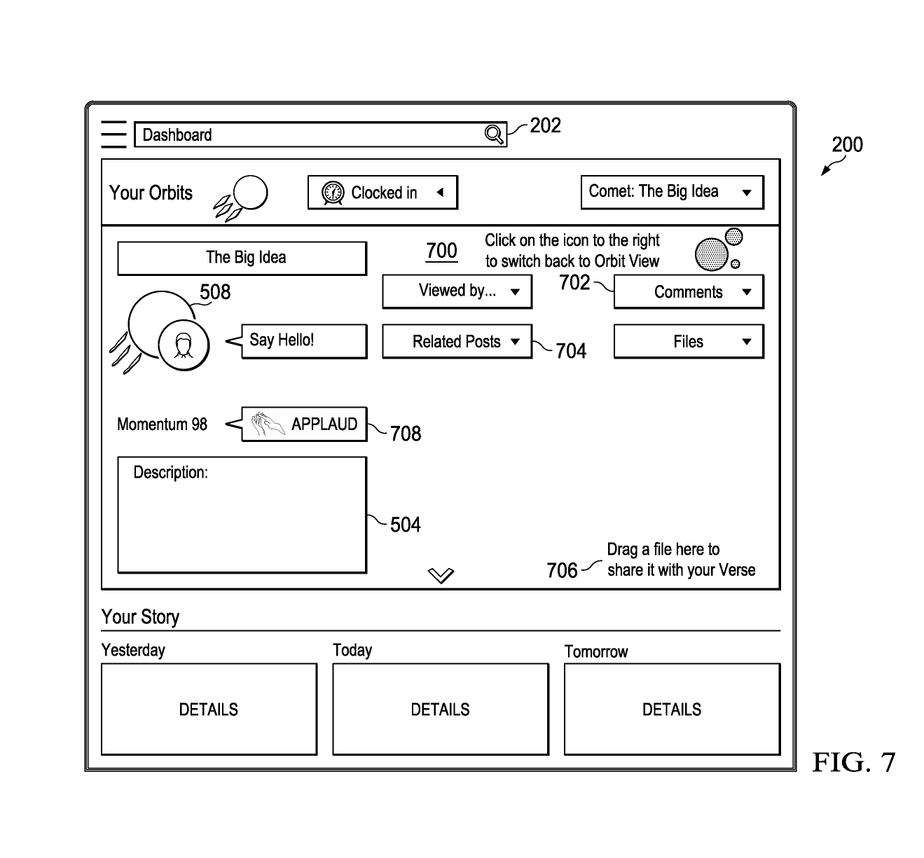

Referring now to FIG. 7, an illustration of a comet detail page is depicted in accordance with an illustrative embodiment. Comet detail page 700 is displayed within the dashboard 202 of graphical user interface 200 of a profile-based workflow system 102 of FIG. 1.

By selecting comet 508, employer personnel 104 of FIG. 1 can display comet detail page 700 in dashboard 202. Comet detail page 700 allows employer personnel 104 to view business idea 504 associated with comet 508. Employer personnel 104 can also view comments 702 that have been posted to comet 508, as well as related discussions 704 that concern business idea 504.

Employer personnel 104 can increase gravity 122 of FIG. 1 of comet 508 by posting comments 702 to comet 508, appending attachments 706 to comet 508, and providing positive feedback 708 to comet 508. Based in part on gravity 122 of comet 508, relevancy broker 124 of FIG. 1 can automatically distribute comet 508 to other content objects 106 of FIG. 1, such as object representing employer personnel 104, which share a large amount of gravity 122 for relevant topics 126 of FIG. 1 with comet 508.

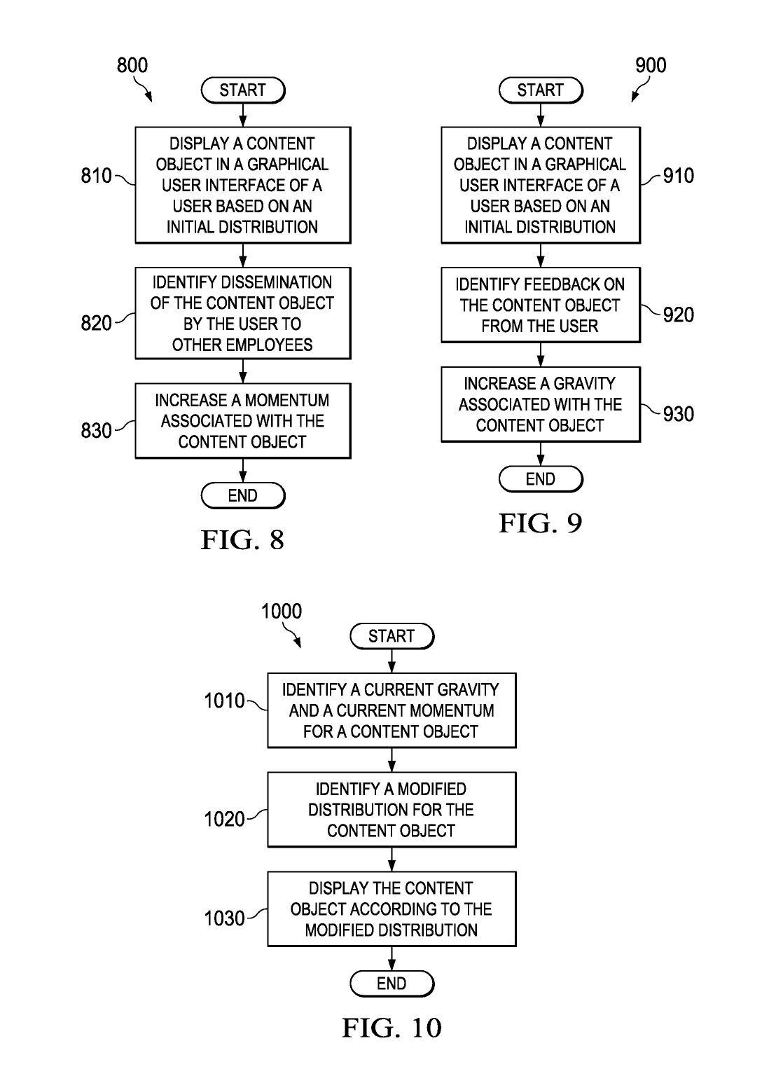

Referring now to FIG. 8, an illustration of a flowchart of a process for increasing visibility of a content object within the profile-based workflow system based on distribution of the content object is shown according to an illustrative embodiment. As depicted, process 800 may be implemented within relevancy broker 124 of profile-based workflow system 102 of FIG. 1. As depicted, increased visibility of the content object based on distribution of the content object may be momentum 128 of FIG. 1.

Process 800 begins by displaying a content object in a graphical user interface of a user based on an initial distribution (step 810). The user can be, for example employee 304 of FIG. 3. The content object, can be a comet including a business idea, such as comet 148 and business idea 146 of FIG. 1. The content object may be initially displayed based on an initial distribution of the content object, such as initial distribution 150 of FIG. 1.

Process 800 identifies dissemination of the content object by the user to other employees (820). In one illustrative embodiment, relevancy broker 124 identifies dissemination of the content objects when employee 304 forwards comet 148 to connected employees 306, 308, 310, 312, 314, or 316 of FIG. 3.

Responsive to identifying dissemination of the content object by the user to other employees, process 800 increases a momentum associated with the content object (step 830), with the process terminating thereafter.

Referring now to FIG. 9, an illustration of a flowchart of a process for increasing visibility of a content object within a profile-based workflow system based on feedback to the content object is shown according to an illustrative embodiment. As depicted, increased visibility of the content object based on feedback to the content object may be gravity 122 of FIG. 1.

Process 900 begins by displaying a content object in a graphical user interface of a user based on an initial distribution (step 910). The user can be, for example employee 304 of FIG. 3. The content object, can be a comet including a business idea, such as comet 148 and business idea 146 of FIG. 1. The content object may be initially displayed based on an initial distribution of the content object, such as initial distribution 150 of FIG. 1.

Process 900 identifies feedback on the content object from the user (920). In one illustrative embodiment, relevancy broker 124 identifies feedback on the content object when employee 304 makes contributions to the content object. Contributions by the associated one of employer personnel 104 of FIG. 1 may include for example but not limited to, at least one of comments on the business idea, open discussions regarding the business idea, questions about the business idea, e-mail, appending files to the business idea, and the like.

Responsive to identifying feedback on the content object from the user, process 900 increases a gravity associated with the content object (step 930), with the process terminating thereafter.

Referring now to FIG. 10, an illustration of a flowchart of a process for increasing visibility of a content object within a profile-based workflow system based on feedback to the content object is shown according to an illustrative embodiment. As depicted, process 1000 may be implemented within relevancy broker 124 of profile-based workflow system 102 of FIG. 1. As depicted, increased visibility of the content object based on distribution of the content object may be momentum 128 of FIG. 1. As depicted, increased visibility of the content object based on feedback to the content object may be gravity 122 of FIG. 1.

Process 1000 begins by identifying a current gravity and a current momentum for a content object (step 1010). The current momentum can be, for example, momentum 128 of FIG. 1, determined by the process similar to process 800 of FIG. 8. Current gravity can be, for example, gravity 122 of FIG. 1, determined by a process similar to process 900 in FIG. 9.

Responsive to identifying the current gravity and current momentum, process 1000 identifies a modified distribution for the content object (step 1020). The modified distribution can be, for example, modified distribution 152 of FIG. 1. As explained above, modified distribution 152 is ones of employer personnel 104 of FIG. 1 selected by relevancy broker 124 of FIG. 1 as recipients of the content object, based at least in part on the current gravity and current momentum of the content object. As the momentum and gravity of the content object increases, relevancy broker 124 can display the content object to a broader range of employer personnel 104. In this manner, the content objects that have been determined to be highly relevant, based on a high gravity 122 and momentum 128, can be exposed to including employer personnel 104 that may not share gravity for relevant topics expressed in the content object.

Process 1000 displays the content object according to the modified distribution (step 1030), with the process terminating thereafter. In an illustrative embodiment, Relevancy broker 124 displays the content object, such as comet 508, within contextual relationships section 204 of dashboard 202 of FIG. 2. Relevancy broker 124 displays the content object as having a loose association. Additionally, relevancy broker 124 displays the content object within information feeds 206 of FIG. 2 of dashboard 202, based on content parsed by relevancy broker 124 from the content object.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, in hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware.

In some alternative implementations of an illustrative embodiment, the function or functions noted in the blocks may occur out of the order noted in the Figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

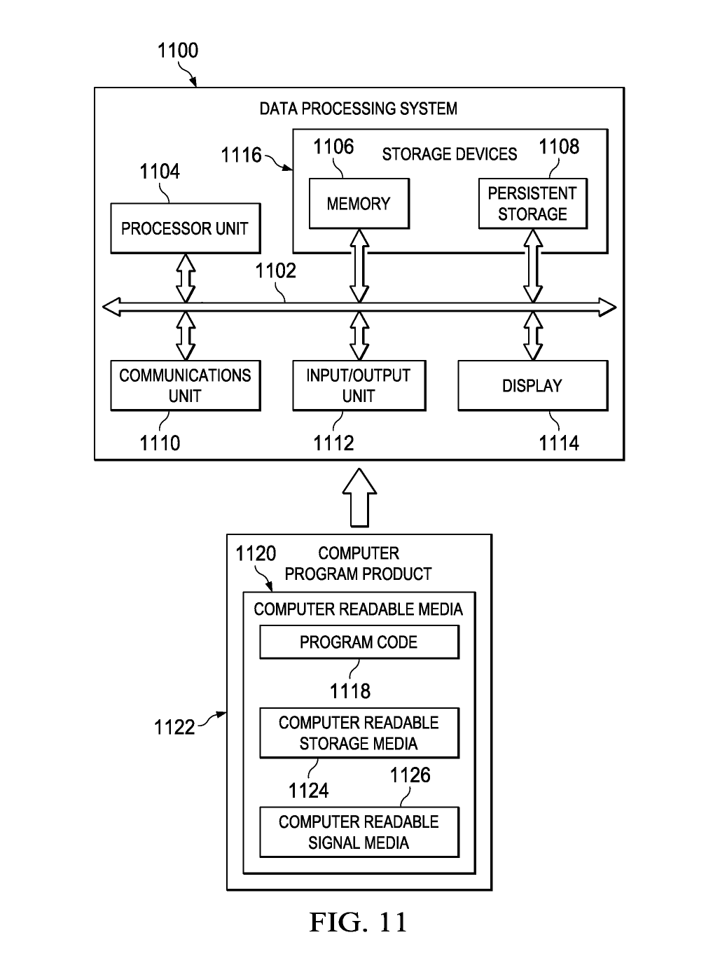

Turning now to FIG. 11, an illustration of a block diagram of a data processing system is depicted in accordance with an illustrative embodiment. Data processing system 1100 may be used to implement one or more data processing systems in profile-based workflow system 102 in FIG. 1. In this illustrative example, data processing system 1100 includes communications framework 1102, which provides communications between processor unit 1104, memory 1106, persistent storage 1108, communications unit 1110, input/output unit 1112, and display 1114. In this example, communication framework may take the form of a bus system.

Processor unit 1104 serves to execute instructions for software that may be loaded into memory 1106. Processor unit 1104 may be a number of processors, a multi-processor core, or some other type of processor, depending on the particular implementation.

Memory 1106 and persistent storage 1108 are examples of storage devices 1116. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1116 may also be referred to as computer readable storage devices in these illustrative examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that may be connected to data processing system 1100. For example, input/output unit 1112 may provide a connection for user input through at least of a keyboard, a mouse, or some other suitable input device. Further, input/output unit 1112 may send output to a printer. Display 1114 provides a mechanism to display information to a user.

Instructions for at least one of the operating system, applications, or programs may be located in storage devices 1116, which are in communication with processor unit 1104 through communications framework 1102. The processes of the different embodiments may be performed by processor unit 1104 using computer-implemented instructions, which may be located in a memory, such as memory 1106.

These instructions are referred to as program code, computer usable program code, or computer readable program code that may be read and executed by a processor in processor unit 1104. The program code in the different embodiments may be embodied on different physical or computer readable storage media, such as memory 1106 or persistent storage 1108.

Program code 1118 is located in a functional form on computer readable media 1120 that is selectively removable and may be loaded onto or transferred to data processing system 1100 for execution by processor unit 1104. Program code 1118 and computer readable media 1120 form computer program product 1122 in these illustrative examples. In one example, computer readable media 1120 may be computer readable storage media 1124 or computer readable signal media 1126.

In these illustrative examples, computer readable storage media 1124 is a physical or tangible storage device used to store program code 1118 rather than a medium that propagates or transmits program code 1118.

Alternatively, program code 1118 may be transferred to data processing system 1100 using computer readable signal media 1126. Computer readable signal media 1126 may be, for example, a propagated data signal containing program code 1118. For example, computer readable signal media 1126 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1100 are not meant to provide architectural limitations to the manner in which different embodiments may be implemented. The different illustrative embodiments may be implemented in a data processing system including components in addition to or in place of those illustrated for data processing system 1100. Other components shown in FIG. 11 can be varied from the illustrative examples shown. The different embodiments may be implemented using any hardware device or system capable of running program code 1118.

Thus, the illustrative embodiments provide a method and apparatus for graphically displaying data within profile-based workflow system that allows dependencies to be readily organized, viewed, and optionally made available to workers so that they can gain a greater understanding of how their work effort impacts and enables others to contribute to such goals. A user interface can be configured to facilitate visualizing these dependencies in an orbit-like view that structures the dependencies into hierarchical levels of dependence that correspond to relative distance from a central theme while supporting pop-up like viewing of dependency details.

Profile-based workflow and information organization methods and systems described herein may facilitate collaborative efforts, such as refining and embellishing innovative ideas by enabling structured, yet dynamic sharing of ideas, refinements, feedback and the like among members of an organization and/or third parties, such as customers who may provide feedback or may initiate requests for new features in a product, and the like. A user may submit an idea for a new product feature through a profile-based workflow and information organization interface. Submissions may have predefined initial distributions that may be based on aspects of the user's profile. An initial distribution may include the user's direct supervisor, coworkers, a team leader, an invention submission portal, a customer relationship management system, and the like.

A digital object that contains a business idea, concept or objective is potentially relevant to a group of individuals or associates, such as a work group, a business network an enterprise, or the like. The illustrative embodiments provide a set of rules and operative characteristics together with the digital object that govern the progress of the object as it is transmitted through the network. The rules and operative characteristics relate to transmission of the object through the network and actions of particular individuals with respect to the comet.

The illustrative embodiments provide that the object may be transmitted based on anticipated relevance of the comet to individuals within the network, such relevance being determined by various techniques, such as based on keywords or attributes associated with individuals that match keywords or topics associated with the comment, by collaborative filtering techniques that promote transmission to individuals that share interests or attributes with other individuals who have expressed interest, or the like.

Distribution of a digital object according to the illustrative embodiments therefore promote informal brainstorming and facilitates distribution of an idea expressed as part of the digital object on a dynamically measured degree of interest in the idea to members of a network and relevance to the types of things being transmitted over the network by the members. As the idea in the digital object receives positive feedback (e.g. increasing interest), the idea may be distributed to more and more members of the network. The members of the network to receive the comet may be based on relevance of the information in the idea of the comet to work product or other data that the members are accessing or producing. In this way, the illustrative embodiments distribute ideas that are interesting to members in a manner where the idea can gain greater visibility in an organization.

The description of the different illustrative embodiments has been presented for purposes of illustration and description, and is not intended to be exhaustive or limited to the embodiments in the form disclosed. The different illustrative examples describe components that perform actions or operations. In an illustrative embodiment, a component may be configured to perform the action or operation described. For example, the component may have a configuration or design for a structure that provides the component an ability to perform the action or operation that is described in the illustrative examples as being performed by the component. In particular, evaluation auditor is configured to perform the different operations described as well as other operations using at least one of program code, hardware, firmware, or other suitable components.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of distributing a content object within a profile-based workflow system, the method comprising:
identifying a measure of relevance between the content object and an employer personnel, wherein the measure of relevance is based on interest indicated by the employer personnel in relevant topics of the content object;
identifying a reviewer-indicated potential value of the content object, wherein the reviewer-indicated potential value is measured by a determination of a degree to which the content object is distributed to additional employer personnel; and
displaying the content object to the employer personnel based on the reviewer-indicated potential value and the measure of relevance.

2. The method of claim 1, wherein the measure of relevance between the content object in the additional employer personnel is expressed as a gravity of the content object.

3. The method of claim 2, wherein gravity is based on a relevance of a business idea of the content object to interest indicated by the employer personnel in relevant topics associated with the content object in a platform for profile-based workflow and information organization.

4. The method of claim 3, wherein interest is derived from contributions by the employer personnel to other content objects of the platform.

5. The method of claim 4, wherein contributions by the employer personnel are selected from contributions consisting of at least one of comments on the other content objects, open discussions on the other content objects, questions on the other content objects, e-mail on the other content objects, data transfer on the other content objects, project affiliations on the other content objects, user profile, accomplishments, training, role in an organization, and combinations thereof.

6. The method of claim 1, wherein the reviewer-indicated potential value of the content object is expressed as a momentum of the content object.

7. The method of claim 6, wherein momentum is determined by the reviewer-indicated potential value of the content object, the reviewer-indicated potential value consisting of at least one of exchanges about the content object by a reviewer, forwarding the content object from the reviewer to the additional employer personnel, indicating associations by the reviewer of the content object to other content objects accessible through the profile-based workflow system, and combinations thereof.

8. The method of claim 6, wherein the momentum include the degree to which the content object is distributed to the additional employer personnel in a platform for profile-based workflow and information organization.

9. The method of claim 6, wherein the momentum is disproportionately impacted by the reviewer based on a role of reviewer in an organization.

10. The method of claim 1, wherein content object is displayed as a comet having a loose association with an orbit of the employer personnel.

11. A computer system comprising:
a display system; and
a profile-based workflow system in the computer system in communication with the display system, wherein the profile-based workflow system identifies a measure of relevance between a content object and an employer personnel, wherein the measure of relevance is based on interest indicated by the employer personnel in relevant topics of the content object; identifies a reviewer-indicated potential value of the content object, wherein the reviewer-indicated potential value is measured by a determination of a degree to which the content object is distributed to additional employer personnel; and displays the content object to the employer personnel based on the reviewer-indicated potential value and the measure of relevance.

12. The computer system of claim 11, wherein the measure of relevance between the content object in the additional employer personnel is expressed as a gravity of the content object.

13. The computer system of claim 12, wherein gravity is based on a relevance of a business idea of the content object to interest indicated by the employer personnel in relevant topics associated with the content object in a platform for profile-based workflow and information organization.

14. The computer system of claim 13, wherein expressed interest is derived from contributions by the employer personnel to other content objects of the platform.

15. The computer system of claim 14, wherein contributions by the employer personnel are selected from contributions consisting of at least one of comments on the other content objects, open discussions on the other content objects, questions on the other content objects, e-mail on the other content objects, data transfer on the other content objects, project affiliations on the other content objects, user profile, accomplishments, training, role in an organization, and combinations thereof.

16. The computer system of claim 11, wherein the reviewer-indicated potential value of the content object is expressed as a momentum of the content object.

17. The computer system of claim 16, wherein momentum is determined by the reviewer-indicated potential value of the content object, the reviewer-indicated potential value consisting of at least one of exchanges about the content object by a reviewer, forwarding the content object from the reviewer to the additional employer personnel, indicating associations by the reviewer of the content object to other content objects accessible through the profile-based workflow system, and combinations thereof.

18. The computer system of claim 16, wherein the momentum include the degree to which the content object is distributed to the additional employer personnel in a platform for profile-based workflow and information organization.

19. The computer system of claim 16, wherein the momentum is disproportionately impacted by the reviewer based on a role of reviewer in an organization.

20. The computer system of claim 11, wherein content object is displayed as a comet having a loose association with an orbit of the employer personnel.

21. A computer program product for distributing a content object within a profile-based workflow system, the computer program product comprising:
a computer readable storage media;
first program code, stored on the computer readable storage media, for identifying a measure of relevance between the content object and an employer personnel, wherein the measure of relevance is based on interest indicated by the employer personnel in relevant topics of the content object;
second program code, stored on the computer readable storage media, for identifying a reviewer-indicated potential value of the content object, wherein the reviewer-indicated potential value is measured by a determination of a degree to which the content object is distributed to additional employer personnel; and
third program code, stored on the computer readable storage media, for displaying the content object to the employer personnel based on the reviewer-indicated potential value and the measure of relevance.

22. The computer program product of claim 21, wherein the measure of relevance between the content object in the additional employer personnel is expressed as a gravity of the content object.

23. The computer program product of claim 22, wherein gravity is based on a relevance of a business idea of the content object to interest indicated by the employer personnel in relevant topics associated with the content object in a platform for profile-based workflow and information organization.

24. The computer program product of claim 23, wherein expressed interest is derived from contributions by the employer personnel to other content objects of the platform.

25. The computer program product of claim 24, wherein contributions by the employer personnel are selected from contributions consisting of at least one of comments on the other content objects, open discussions on the other content objects, questions on the other content objects, e-mail on the other content objects, data transfer on the other content objects, project affiliations on the other content objects, user profile, accomplishments, training, role in an organization, and combinations thereof.

26. The computer program product of claim 21, wherein the reviewer-indicated potential value of the content object is expressed as a momentum of the content object.

27. The computer program product of claim 26, wherein momentum is determined by the reviewer-indicated potential value of the content object, the reviewer-indicated potential value consisting of at least one of exchanges about the content object by a reviewer, forwarding the content object from the reviewer to the additional employer personnel, indicating associations by the reviewer of the content object to other content objects accessible through the profile-based workflow system, and combinations thereof.

28. The computer program product of claim 26, wherein the momentum include the degree to which the content object is distributed to the additional employer personnel in a platform for profile-based workflow and information organization.

29. The computer program product of claim 26, wherein the momentum is disproportionately impacted by the reviewer based on a role of reviewer in an organization.

30. The computer program product of claim 21, wherein content object is displayed as a comet having a loose association with an orbit of the employer personnel.
